(19) United States
(12) Patent Application Publication
(10) Pub. No.: US 2025/0239803 A1
(43) Pub. Date: Jul. 24, 2025

(54) CONNECTOR AND ASSEMBLY METHOD FOR A CONNECTOR

(71) Applicant: MD Elektronik GmbH, Waldkraiburg (DE)

(72) Inventors: Florian KEINDL, Mühldorf am Inn (DE); Sebastian MIRZ, Kraiburg am Inn (DE); Alexander ANDERT, Waldkraiburg (DE)

(21) Appl. No.: 19/008,738

(22) Filed: Jan. 3, 2025

(30) Foreign Application Priority Data
Jan. 24, 2024 (DE) 10 2024 102 059.8

(51) Int. Cl. H01R 13/506; H01R 24/40; H01R 43/18; H01R 103/00

(52) U.S. Cl. CPC H01R 13/506; H01R 24/40; H01R 43/18; H01R 2103/00

(57) ABSTRACT

A connector for a cable includes a housing, a through-opening formed in the housing along a first direction between a first side and a second side, and a contact carrier, which is insertable into the through-opening, configured to fasten the cable in the housing. The contact carrier has a first fastener, which is rigid or flexible, configured to fasten the contact carrier to the cable. The contact carrier also has a separate second fastener, which has a flexible configuration, configured to fasten the contact carrier in the housing.

### CROSS REFERENCE TO RELATED APPLICATIONS

This application claims benefit to German Patent Application No. DE 10 2024 102 059.8, filed on Jan. 24, 2024, which is hereby incorporated by reference herein.

### FIELD

The invention relates to a connector and an assembly method for a connector for and/or on a cable, particularly a coaxial cable.

### BACKGROUND

Housings, in particular plastic housings, for coaxial plug connections serve the purpose of enclosing the electrical (connector) contact or contacts and ensuring a mechanical closure of the overall (connector) system. The basic structure of the overall (connector) system comprises a pin housing and a coupler housing. In each pin and coupler housing, a primary locking mechanism ensures that the contact or contacts are fixed and remain fixed in their respective housing. Optionally, each pin and coupler housing can also have secondary locking mechanisms to additionally secure the mechanical locking (of the primary locking mechanism). Additionally, a further optional safety feature (so-called Connector Position Assurance-CPA) can prevent unintentional detaching of the plug connection. The mentioned housing variants can alternatively be configured to be watertight.

In the automotive sector, this primarily concerns all known FAKRA and Mini-Coax systems. There are known requirements from standards and specifications for primary and secondary locking mechanisms, mating assurance, ease of assembly and/or disassembly and similar features.

In the prior art, lateral joining of the secondary locking mechanism is not possible in watertight systems, as no closed (and therefore sealed) housing would be formed. Furthermore, prior art (connector) systems usually have a secondary locking mechanism that only locks the movable primary latch hook but does not create an additional engagement. This type of structure creates low mechanical stability. Additionally, disassembly is often complicated or only possible through destruction.

Further disadvantages resulting from the prior art recognized by embodiments of the present invention are: a high variance or number of different geometries of (connector) housings, for example for a watertight and a non-watertight housing. As a result, different operating resources must still be procured for these high variances, which means high investments, and different processes, such as joining, plugging, etc., must be carried out. As a result the effort increases and the manufacturing chain is extended, which ultimately makes the product expensive to manufacture.

### SUMMARY

In an embodiment, the present disclosure provides a connector for a cable. The connector includes a housing, a through-opening formed in the housing along a first direction between a first side and a second side, and a contact carrier, which is insertable into the through-opening, configured to fasten the cable in the housing. The contact carrier has a first fastener, which is rigid or flexible, configured to fasten the contact carrier to the cable. The contact carrier also has a separate second fastener, which has a flexible configuration, configured to fasten the contact carrier in the housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of an embodiment of a connector;

FIG. 2 shows a cross-sectional view of the embodiment of the connector from FIG. 1 along the first direction;

FIG. 3 shows a perspective view of an embodiment of a housing;

FIG. 4 shows a perspective view of an embodiment of a contact carrier;

FIG. 5 shows a further perspective view of the embodiment of the contact carrier from FIG. 4;

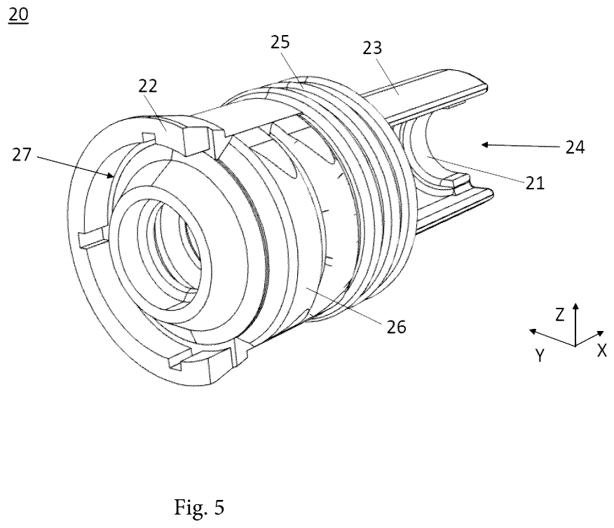

FIG. 6 shows a cross-sectional view of the embodiment of the contact carrier from FIG. 4 along the first direction;

FIG. 7 shows a perspective view of an embodiment of a cable provided with a contact region;

FIG. 8 shows a perspective view of an embodiment of the cable from FIG. 7, on which a contact carrier is arranged;

FIG. 9 shows a perspective view of an embodiment of the cable of FIG. 7, on which a cap is arranged; and

FIG. 10 shows a perspective view of an embodiment of the cable from FIG. 7, on which a cap and a contact carrier are arranged.

### DETAILED DESCRIPTION

Embodiments of the present invention provide a connector and an assembly method which at least partially reduce the above-mentioned disadvantages.

In particular, an embodiment of the present invention at least partially reduces the above-mentioned disadvantages by a connector for a cable comprising a housing, a through-opening formed in the housing along a first direction between a first side and a second side, a contact carrier insertable into the through-opening for fastening the cable in the housing, wherein the contact carrier comprises a first fastener by which the contact carrier can be fastened to the cable, and the first fastener is rigid or flexible, and the contact carrier comprises a separate second fastener by which the contact carrier can be fastened in the housing, and the second fastener is flexible.

The present connector has a primary locking mechanism with the aid of the contact carrier, with a locking taking place at two separate (i.e. spatially separated) points. A first latching or locking between the cable and the contact carrier on the first fastener and a spatially separate, second latching between the contact carrier and the housing via the second fastener. In particular, the first and second fastener are arranged on opposite sides of the contact carrier. The first and second fastener are configured in such a way that they ensure reliable latching and mechanical stability. The first fastener cannot (unintentionally) become detached on their own. The second fastener can be configured to be elastically deformable due to a spatially separated arrangement, whereby the contact carrier and the connector nevertheless provide reliable mechanical stability overall. Specifically, the second fastener is arranged on a first side or cable outlet side of the connector. The first side is opposite a second side or mating side on which the connector can be mated with a suitable mating connector. The spatial separation of the functions, in particular the separation of the primary locking mechanism from the mating side of the connector, enables a connector with a small installation space as well as high reliability and mechanical stability. In particular, the primary locking mechanism is spatially separated from the mating face of the connector. This prevents the primary locking mechanism from having an obstructive impact on an optional mating assurance. A mating assurance can be configured independently of the primary latching and in any desired manner, allowing for a wide application of different mating patterns with the same housing. This keeps the number of components small.

Preferably, the connector further has at least one opening which extends transversely to the first direction between the through-opening and an outer surface of the housing, wherein the second fastener engages in the at least one opening as an undercut when the contact carrier is fully inserted into the housing. The undercut provides a reliable mechanical stability and latching in a small space. Furthermore, the engagement in the undercut can be detached again from the outside through the opening, allowing for simple and non-destructive disassembly of the connector.

Preferably, the contact carrier has a gap along the first direction, with the gap being arranged in a first section. The gap allows the contact carrier to be fastened on the cable laterally and/or through a tilting movement. This enables the contact carrier to be arranged at any desired position on the cable. The contact carrier can thus be inserted directly into a recess on the cable, at least in the first region. A first and/or second seal seals the interior of the housing against external environmental influences such as water or dirt when the contact carrier is inserted.

Preferably, the through-opening has a tunnel section whose inner diameter is selected such that, when the contact carrier is fully inserted into the housing, it prevents the cable from detaching from the contact carrier, and particularly from the first fastener. The rigid or flexible first fastener on the contact carrier, together with the inner wall of the tunnel section, form an insurmountable barrier for the cable when the contact carrier is inserted into the tunnel section, so that the cable cannot detach unintentionally without removing the contact carrier from the housing. As a result a very high reliability of the primary locking mechanism is achieved on the connector.

Preferably, the contact carrier is constructed in one piece, wherein the contact carrier comprises at least a first and a second region, which were preferably formed together in a 2K injection molding process, wherein the first region has a rigid or flexible form and the second region has a flexible form. The one-piece structure of the contact carrier enables simple assembly. The potentially different flexibilities of the material in different regions of the contact carrier allow for optimal adaptation of the fastening or latching means to spatial conditions on the housing, thus achieving good mechanical stability with optimal space utilization (in a small space).

Preferably, the second region has a larger diameter than the first region. On the one hand, the larger diameter, in particular a larger inner diameter, in the second region facilitates the insertion of the cable into the contact carrier. On the other hand, it allows the cable to tilt in this region so that, for example, the first fastener can be guided (at least partially) past a contact region of the cable (tilted out) and then arranged on the cable again (tilted in). Finally, the larger diameter allows for a gap between the cable and the second fastener, so that the second fastener can be moved flexibly in order to engage into the latching or detach from the latching.

Preferably, the connector further comprises a cap that can be locked on the housing and closes off the housing on the first side and the at least one opening. The cap allows for a very simple protected configuration of a connector. No changes to the housing are necessary, which, for example, minimizes the number of different housing components and process steps. The cap protects the connector on at least two different sides, e.g. on the cable outlet side and laterally thereof. In contrast to a simple placing on or a plugging the cap into the housing, as in the prior art, the locking of the cap on the housing provides an additional holder that increases the reliability of the connector. Finally, by covering the at least one opening, the cap protects against unintentional detaching of the second fastener from the outside.

Preferably, the cap has a projection, wherein the projection exerts a preload on the contact carrier when the cap is locked on the housing. Due to the projection, the cap exerts a preload on the contact carrier and thus holds the contact carrier in position. In particular, (material) fatigue phenomena that can lead to undesired play of the contact carrier in the housing, are compensated for by the preload. Due to the projection, the cap also fulfills not only the protective function but also the function of a secondary locking mechanism. The secondary locking mechanism provides protection against unintentional detaching of the latching of the contact carrier in the housing and increases the reliability of the connector. Furthermore, the volume of the projection is preferably formed in such a way that, if the contact carrier is not fully inserted into the housing, the cap either cannot be fully locked on the housing and thus serves as an indicator of an incorrectly assembled connector, or the cap slides the contact carrier into the fully inserted position when it is locked on the housing, whereby both possibilities again increase the reliability of the connector.

The aforementioned problems are further solved, in particular, by an assembly method for a connector to a cable, wherein the connector comprises at least a housing and a contact carrier that can be arranged in the housing, and the assembly method comprises the following steps: providing the cable along a first direction, arranging the contact carrier on the cable, by plugging on or a tilting movement, from a direction transverse to the first direction, and inserting the contact carrier with the cable into the housing along the first direction until the contact carrier latches in the housing.

The step of arranging the contact carrier on the cable, by lateral plugging on and/or a tilting movement, transverse to the first direction, allows the rigid or flexible first fastener to be arranged in a recess on the cable without the first fastener having to be slid on the cable. A sliding of the first fastener on the cable can lead to damage to the cable and/or the fastener. The material thickness and/or shape of the first fastener achieves a high level of fastening reliability when the contact carrier is subsequently fully inserted into the housing. The insertion of the contact carrier along the first direction into the housing, in turn, allows for the formation of a watertight connector and keeps the assembly of the connector simple.

Preferably, the step of arranging the contact carrier on the cable comprises a lateral plugging on transversely, in particular perpendicularly to the first direction, or a guiding along the first direction, wherein the second center axis of the contact carrier is aligned transversely to the first direction, and subsequently tilting, so that the second center axis is aligned on the cable along the first direction. The guiding along the first direction, wherein the second center axis is aligned transversely to the first direction, serves to move the rigid or flexible first fastener next to the cable until the first fastener can be arranged at a suitable position on the cable, namely a recess. The tilting onto the cable takes place at this suitable position.

The following description of embodiments is made with reference to the accompanying figures.

In the following, preferred embodiments are described in detail with reference to the attached figures.

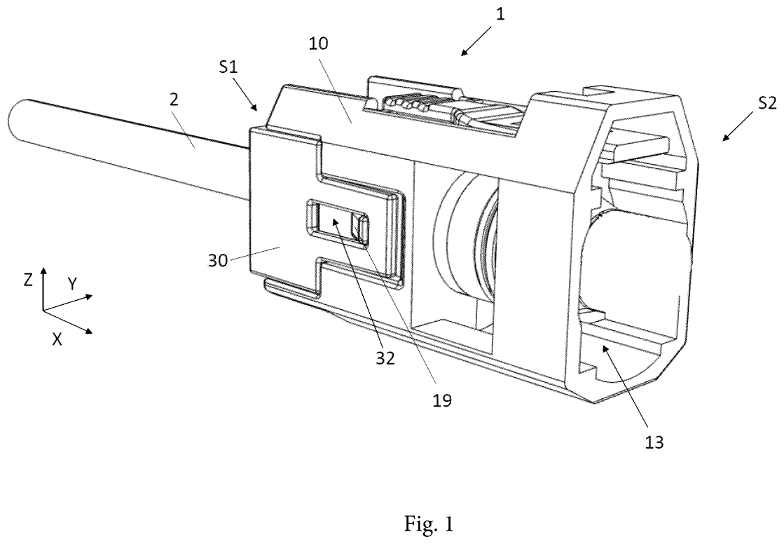

FIG. 1 shows an embodiment of a connector 1 for a cable 2. The connector 1 allows the cable 2 to be connected to a suitable mating connector, which can be attached to another cable or an end user.

The connector 1 has at least one housing 10. The housing 10 is preferably made of plastic and has dimensions ranging from a few millimeters to a few centimeters. In the assembled state, the housing 10 extends along a cable 2 from a first side S1, the so-called cable outlet side, to an opposite second side S2, the so-called mating side, on which the connector 1 can be plugged in a suitable mating connector. A mating is carried out by inserting the mating connector into the receptacle 13 on the mating face of the connector 1, whereby a mating assurance can optionally be used to ensure that only a suitable mating connector can be successfully plugged on the connector 1.

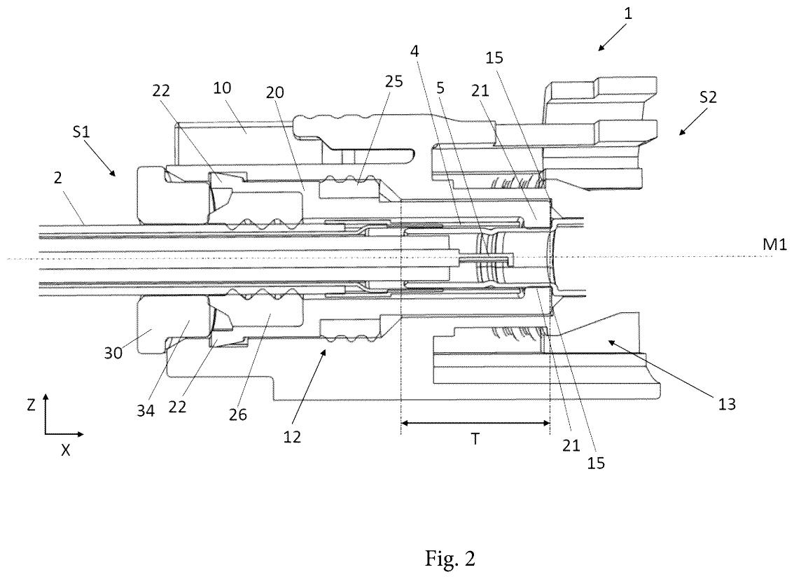

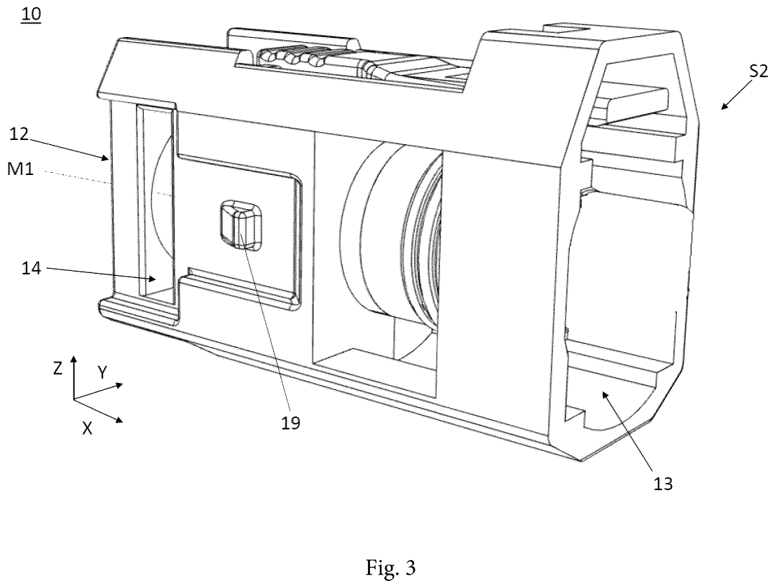

A through-opening 12 is formed in the housing 10 (see FIGS. 2 and 3). The through-opening 12 extends in the housing 10 along a first direction X, which also forms the plugging direction of the connector 1 with a mating connector. The through-opening 12 extends between the first side S1 and the second side S2. The through-opening 12 has at least one tunnel section T, whose inner diameter is selected such that, when the contact carrier 20 is fully inserted into the housing 10, the cable 2 is prevented and/or blocked from detaching from the contact carrier 20, and, in particular from the first fastener 21. At least one stop 15 is arranged or formed at the end of the tunnel section T on the second side S2, which signals maximum insertion of the contact carrier 20 when it is brought to a stop.

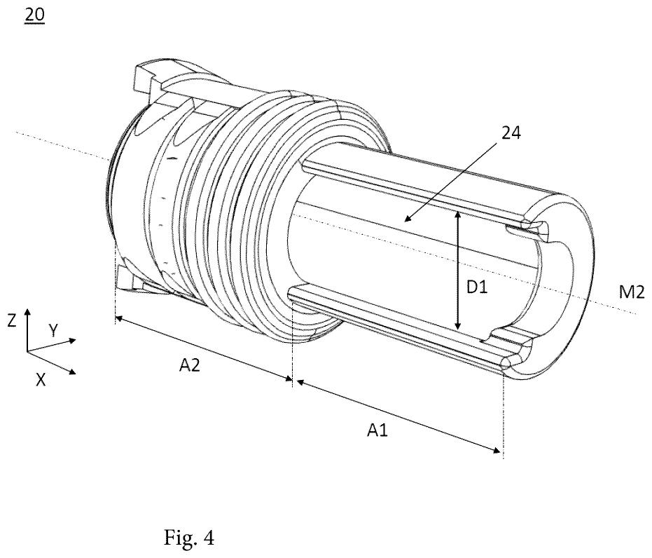

The illustrated connector 1 further comprises a contact carrier 20 that can be inserted into the through-opening 12. A preferred embodiment of the contact carrier 20 is shown in FIG. 4. The contact carrier 20 is fastened to the cable 2 before it is inserted into the housing 10 and/or the through-hole 12. The contact carrier 20 serves to fasten the cable 2 in the housing 10. The contact carrier 20 is a hollow body whose second center axis M2 is arranged along the first center axis M1 of the housing 10 when the contact carrier 20 is in the fully inserted state in the housing 10. In the fully inserted or assembled state, the cable 2 is aligned along the first direction X and the first center axis M1 in the region of the connector 1.

The illustrated contact carrier 20 comprises at least a first fastener 21 with which the contact carrier 20 can be fastened to the cable 2. The illustrated first fastener 21 is rigid and/or stiff and/or dimensionally stable. In an alternative embodiment, the first fastener 21 can be flexible. An example of the flexible first fastener 21 is a latching hook. Preferably, the first fastener 21 is formed as projections integrally with the contact carrier 20. The first fastener 21 can be elastically deformable or not elastically deformable. The first fastener 21 is arranged at a corresponding position on the cable 2 and forms a type of pre-fixing of the contact carrier 20 on the cable 2. In interaction with the housing 10 and/or the tunnel section T of the through-opening 12, the first fastener 21 forms a (final) fixing of the cable 2 in the housing 10 when the contact carrier 20 is fully inserted into the housing 10, as the cable 2 cannot be removed from the fastening without removing the contact carrier 20 from the housing 10.

The illustrated contact carrier also comprises at least a second fastener 22, with which the contact carrier 20 can be fastened in the housing 10. The second fastener 22 is flexible, i.e. elastically deformable. The flexibility is obtained by the choice of plastic material, which is elastically deformable. The second fastener 22 is configured in particular as an at least partially circumferential projection in relation to the contact carrier 20. The second fastener 22 can be compressed radially and expand radially outwards again when the compressive force is removed.

The housing 10 of the connector 1 illustrated in FIG. 3 also comprises at least one opening 14, which extends transversely to the first direction X between the through-opening 12 and an outer surface of the housing 10. The at least one opening 14 is preferably already formed when the housing 10 is formed, but it can also be introduced into the housing 10 at a later stage. The at least one opening 14 preferably has the shape of a slot. The second fastener 22 can engage in the at least one opening 14 as an undercut when the contact carrier 20 is fully inserted into the housing 10 and can thereby fasten the contact carrier 20 to and/or in the housing 10.

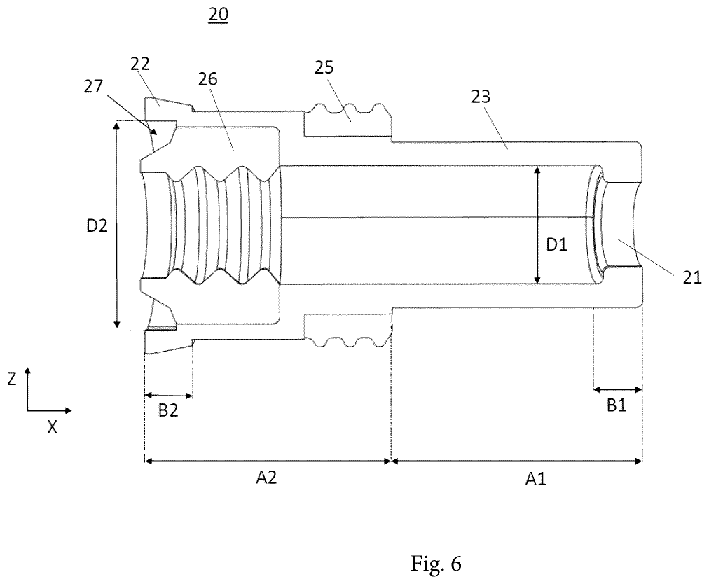

The illustrated contact carrier 20 can be divided into a first section A1 and a second section A2 (see FIG. 6). The first section A1 can be rigid or flexible and comprises the first fastener 21. The second section A2 is flexible at least in the region of the second fastener 22. The contact carrier 20 shown is constructed in one piece. The contact carrier 20 shown can be further subdivided. When subdivided, the contact carrier 20 comprises at least a first and a second region B1, B2, which are connected to one another via a base 23. The first and second region B1, B2 were preferably formed together in a 2 K injection molding process. The first region B1 is located in the first section A1, has a rigid or flexible shape and forms the region of the first fastener 21 along the first direction X. The second region B2 is located in the second section A2, at the opposite end of the contact carrier 20 along the first direction X in relation to the first region B1. The second region B2 has a flexible shape and forms the region of the second fastener 22 along the first direction X. The second region B2 further has a larger second (inner) diameter D2 than the first region B1 with a first (inner) diameter D1. The larger second diameter D2 in the second region B2 allows for play and/or tilting of the cable 2 in the second region B2. The first diameter D1 in the first region B1 tightly surrounds the cable 2 and/or is even slightly smaller than the outer diameter of the cable 2 in large parts, so that the first area B1 can only be arranged in a designated section of the cable 2, the recess 8, which has a smaller outer diameter.

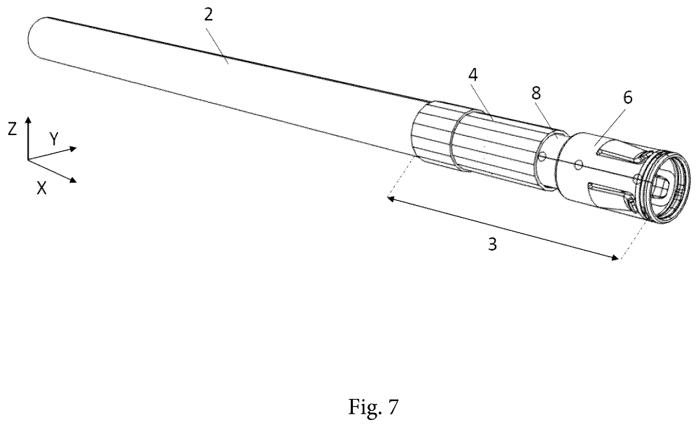

FIG. 7 shows a preferred embodiment of a cable 2. The illustrated cable 2 comprises a coaxial line and/or a coaxial cable with a contact area 3. The contact area 3 has at least one crimp sleeve 4, an inner conductor contact 5 (see FIG. 2), an outer conductor contact 6 and a recess 8. The illustrated recess 8 is formed between the outer conductor contact 6 and the crimp sleeve 4. In alternative embodiments, the recess 8 can also be formed at a different position on the cable 2 and/or by other components or sections with partially removed layers of the cable 2. The recess 8 is preferably formed circumferentially, so that the cable 2 can be arranged in the first fastener 21 at any circumferential section.

The illustrated contact carrier 20 also comprises a gap 24 over the first section A1 along the first direction X. A first and second seal 25, 26 are arranged at least partially circumferentially in the circumferential direction and, in the fully inserted state, seal the through-opening 12 towards the first side S1. The first and second seals 25, 26 are configured to be flexible, i.e. elastically deformable.

For a protected connector 1, the connector 1 further comprises a cap 30 (see FIGS. 1, 9 and 10). The cap 30 can be locked to the housing 10, and closes off the housing 10 on the first side S1 and the at least one opening 14 in a secured manner. The illustrated cap 30 also has a projection 34. The illustrated projection 34 is integrally formed with the cap 30 from plastic and is configured to be circumferential. In the locked state of the cap 30 on the housing 10, the projection 34 shown exerts a preload on the contact carrier 20 and thereby prevents disengagement of the second fastener 22 from the undercut of the at least one opening 14.

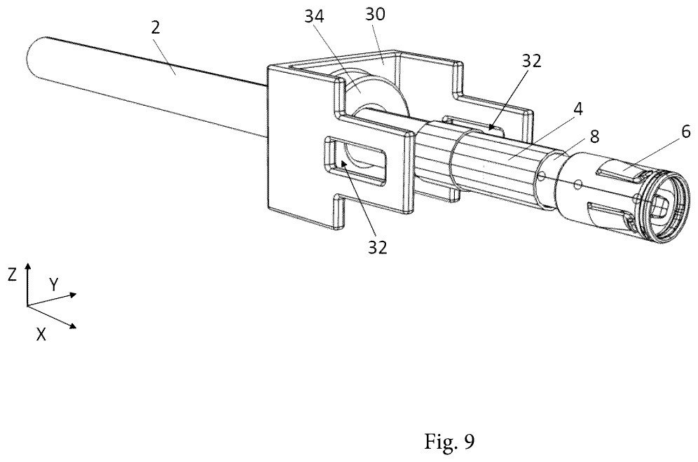

The following describes an assembly method for an illustrated connector 1 on a cable 2 with reference to FIGS. 7-10. The assembly method comprises at least the following steps: first, a cable 2 is provided along a first direction X, as shown in FIG. 7. If a protected connector 1 is assembled, the cap 30 is then first slid along the first direction X from the second side S2 towards the first side S1 and/or from the outer conductor contact 6 towards the cable outlet, onto the cable 2 (see FIG. 9). The sliding of the cap 30, as well as all assembly steps, can be carried out manually, but is preferably carried out automatically.

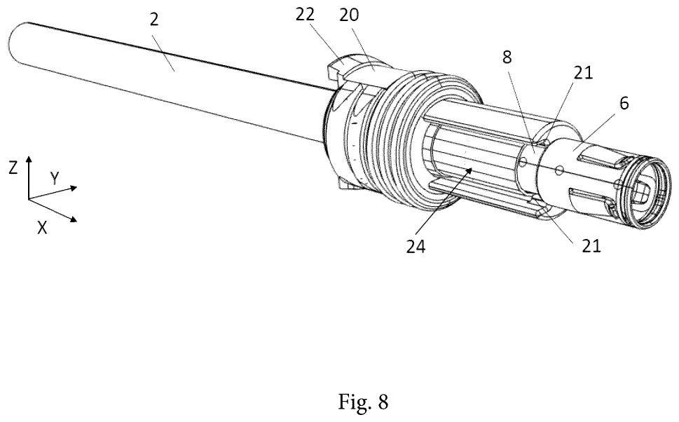

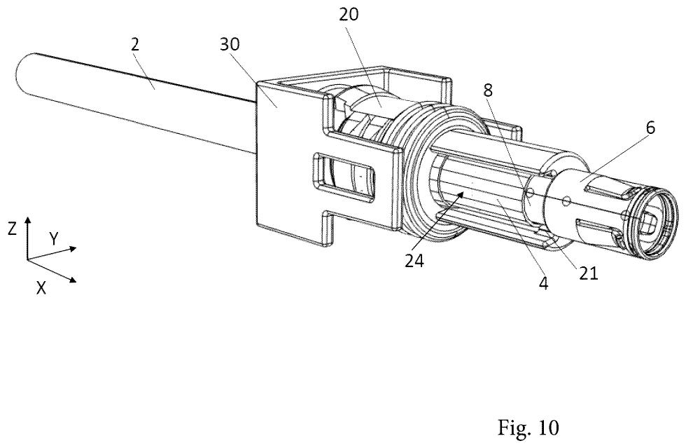

The contact carrier 20 is then arranged on the cable 2. In one embodiment, the illustrated contact carrier 20 is first slid onto the cable 2, with the contact carrier 20 aligned transversely to the first direction X, i.e. at least partially along a second or third direction Y, Z, so that the first fastener 21 runs alongside the cable 2. Only when the first region B1 is located at the level of the recess 8 along the first direction X does a tilting movement of the contact carrier 20 onto the cable 2 occur, so that the contact carrier 20 is aligned along the first direction X (see FIGS. 8 and 10). In this alignment, the first fastener 21 and the cable 2 are in the aforementioned pre-fixing.

Subsequently, the contact carrier 20 with the cable 2 is inserted into the housing 10 along the first direction X until the contact carrier 20 latches in the housing 10. Latching means, on the one hand, that the insertion is carried out until the first region B1 of the contact carrier 20 comes into contact with the stop 15 in the through-opening 12. And, on the other hand, during insertion, the second fastener 22 is automatically compressed when entering the housing 10, and only when the second fastener 22 reaches the at least one opening 14 when the contact carrier 20 is fully inserted into the housing 10 does it expand again and form an engagement with the housing 10. This engagement secures the contact carrier 20 to the housing 10. The engagement can be released when the second fastener 22 is compressed radially inwards from the outside, preferably using auxiliary means, and the contact carrier 20 is simultaneously moved out of the housing 10.

Particularly in the case of a protected connector 1, the cap 30 is finally slid along the cable 2 towards the housing 10 until the fastener 32 on the cap 30 engages and/or latches with latching means 19 on the housing 10 (see FIG. 1). The latching secures the cap 30 on the housing 10 and additionally prevents unintentional removal of the contact carrier 20 from the housing 10. In order for the illustrated cap 30 to latch with the projection 34 on the housing 10, the contact carrier 20 must be in the fully inserted position and/or the fully assembled state. If the contact carrier 20 is not in the fully inserted position, the contact carrier 20 can either be brought into the fully inserted position by exerting increased pressure on the cap 30 towards the housing 10 until the cap 30 latches on the housing 10. Or the non-latching of the cap 30 serves as an indicator that the connector 1 has not been properly assembled. The latching or non-latching is easily visible from the outside and could be particularly recognized by automated testing processes.

The latched cap 30 can be removed from the housing 10 in a non-destructive manner, preferably with the aid of tools. When the connector 1 is completely disassembled, the second fastener 22 is subsequently detached from the housing 10 and/or from the at least one opening 14, preferably with the aid of tools. At the same time, the contact carrier 20 is removed from the housing 10 and/or the housing 10 is removed from the contact carrier 20 over the outer conductor contact 6. Finally, the contact carrier 20 and the cable 2 are separated from each other by tilting the first fastener 21 out of the recess 8 on the cable 2 and/or removing them sideways.

The preferred embodiments described have the following summarized functions with regard to a primary and secondary locking mechanism. The contact carrier 20 and the housing 10 are two separate components which, when assembled, fulfill the function of a primary locking mechanism (for the cable 2 in the connector 1). In this primary locking mechanism, the functions ‘fixing the cable 2 in the contact carrier 20’ and ‘fixing the contact carrier 20 in the housing 10’ are implemented at two different locations. The fixing of the cable 2 in the contact carrier 20 takes place via the first fastener 21 in the first region B1. The fixing of the contact carrier 20 in the housing 10 takes place via the separate and spatially separated second fastener 22 along the contact carrier 20 in the second region B2. Due to the spatial separation of the two functions, the structure of the connector 1 can be kept very small and yet mechanically stable. A secondary locking mechanism can optionally be added. The secondary locking mechanism is formed by the projection 34 of the cap 30 exerting a preload on the contact carrier 20. The present secondary locking mechanism thus does not act as a barrier against the primary locking mechanism being released from the cable, as in the prior art, but rather as a barrier against the contact carrier 20 being released from the housing 10, whereby (unintentional) release of the cable 2 from the contact carrier 20 is also indirectly prevented. Due to the operating principle of the present secondary locking mechanism, the connector can be designed very effectively and, for example, can advantageously combine the function of secondary locking with the function of (additional) protection. Additional safety devices such as a CPA can be arranged on the primary and secondary locking on the housing 10 without any disadvantages.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1 connector
2 cable
3 contact region
4 crimp sleeve
5 inner conductor contact
6 outer conductor contact
8 recess
10 housing
12 through-opening
13 receptacle
14 opening
15 stop
19 latching means
20 contact carrier
21 first fastener
22 second fastener
23 base
24 gap
25 first seal
26 second seal
27 annular gap
30 cap
32 fastener
34 projection
A1 first section
A2 second section
B1 first region
B2 second region
D1 first diameter
D2 second diameter
M1 first center axis
M2 second center axis
S1 first side
S2 second side
T tunnel section
X first direction
Y second direction
Z third direction

What is claimed is:

1. A connector for a cable comprising:
a housing;
a through-opening formed in the housing along a first direction between a first side and a second side; and
a contact carrier, which is insertable into the through-opening, configured to fasten the cable in the housing,
wherein the contact carrier has a first fastener, which is rigid or flexible, configured to fasten the contact carrier to the cable, and
wherein the contact carrier has a separate second fastener, which has a flexible configuration, configured to fasten the contact carrier in the housing.

2. The connector according to claim 1, further comprising at least one opening which extends transversely to the first direction between the through-opening and an outer surface of the housing, wherein the second fastener engages in the at least one opening as an undercut in a state in which the contact carrier is fully inserted into the housing.

3. The connector according to claim 2, further comprising a cap that is lockable to the housing and closes off the housing on the first side and the at least one opening.

4. The connector according to claim 3, wherein the cap has a projection, and wherein the projection exerts a preload on the contact carrier in a state in which the cap is locked on the housing.

5. The connector according to claim 1, wherein the contact carrier has a gap along the first direction, and wherein the gap is arranged in a first section.

6. The connector according to claim 1, wherein the through-opening has a tunnel section, an inside diameter of the tunnel section being sized such that, in a state in which the contact carrier is fully inserted into the housing, a detaching of the cable from the contact carrier is prevented,

7. The connector according to claim 6, wherein the inside diameter of the tunnel selection is sized such that, in the state in which the contact carrier is fully inserted into the housing, a detaching of the cable from the first fastener is prevented.

8. The connector according to claim 1, wherein the contact carrier is constructed in one piece, wherein the contact carrier comprises at least a first and a second region, and wherein the first region has a rigid or flexible shape and the second region has a flexible shape.

9. The connector according to claim 8, wherein the first and second region were formed together in a 2 K injection molding process.

10. The connector according to claim 8, wherein the second region has a larger diameter than the first region.

11. An assembly method for a connector to a cable, wherein the connector comprises at least a housing and a contact carrier which is arrangeable in the housing, the assembly method comprising:
providing the cable along a first direction;
arranging the contact carrier on the cable, by plugging on or a tilting movement, from a direction transverse to the first direction; and
inserting the contact carrier with the cable into the housing along the first direction until the contact carrier latches in the housing.

12. The assembly method according to claim 10, wherein the step of arranging the contact carrier on the cable comprises:
lateral plugging on transversely to the first direction, or
guiding along the first direction, wherein the second center axis of the contact carrier is aligned transversely to the first direction, and subsequently tilting, so that the second center axis is aligned on the cable along the first direction.
